(19) United States
(12) Patent Application Publication
(10) Pub. No.: US 2009/0306983 A1
(43) Pub. Date: Dec. 10, 2009

(54) USER ACCESS AND UPDATE OF PERSONAL HEALTH RECORDS IN A COMPUTERIZED HEALTH DATA STORE VIA VOICE INPUTS

(75) Inventor: Vaibhav Bhandari, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/135,212

(22) Filed: Jun. 9, 2008

(51) Int. Cl. G10L 15/04; G06F 19/00

(52) U.S. Cl. 704/251; 704/270.1; 705/3; 704/E15.005

(57) ABSTRACT

Systems and methods for enabling user access and update of personal health records stored in a health data store via voice inputs are provided. The system may include a computer program having a recognizer module configured to process structured word data of a user voice input received from a voice platform, to produce a set of tagged structured word data based on a healthcare-specific glossary. The computer program may further include a health data store interface configured to apply a rule set to the tagged structured word data to produce a query to the health data store and receive a response from the health data store based on the query, and a grammar generator configured to generate a reply sentence based on the response received from the health data store and pass the reply sentence to the voice platform to be played as a voice reply to the user.

### BACKGROUND

Centralized online databases have been used to electronically store patient healthcare records, allowing patients and healthcare providers to access the patient healthcare records from remote locations. Patient access to these healthcare records via such a centralized online database is made using a computer connected to the Internet. Yet, not all patients have a computer or Internet access, and not all patients are capable of operating a computer. For example, elderly patients and users with certain physical or mental disabilities may not be capable of inputting information via a computer keyboard in a manner sufficient to access personal healthcare records. Further, patients who are traveling may find themselves away from a computer at a time when access to a personal healthcare record is desired.

### SUMMARY

Systems and methods for enabling user access and update of personal health records stored in a computerized health data store via voice inputs are provided herein. The system may include a computer program having a recognizer module configured to process structured word data of a user voice input received from a voice platform, to produce a set of tagged structured word data based on a healthcare-specific glossary. The computer program may further include a health data store interface configured to apply a rule set to the tagged structured word data to produce a query to the health data store and receive a response from the health data store based on the query, and a grammar generator configured to generate a reply sentence based on the response received from the health data store and pass the reply sentence to the voice platform to be played as a voice reply to the user.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic view illustrating an embodiment of a system for providing a user the ability to access and update secured personal healthcare record data via voice inputs.

FIGS. 2A and 2B are a flowchart illustrating an embodiment of a method for providing a user the ability to access and update secured personal healthcare record data via voice inputs.

### DETAILED DESCRIPTION

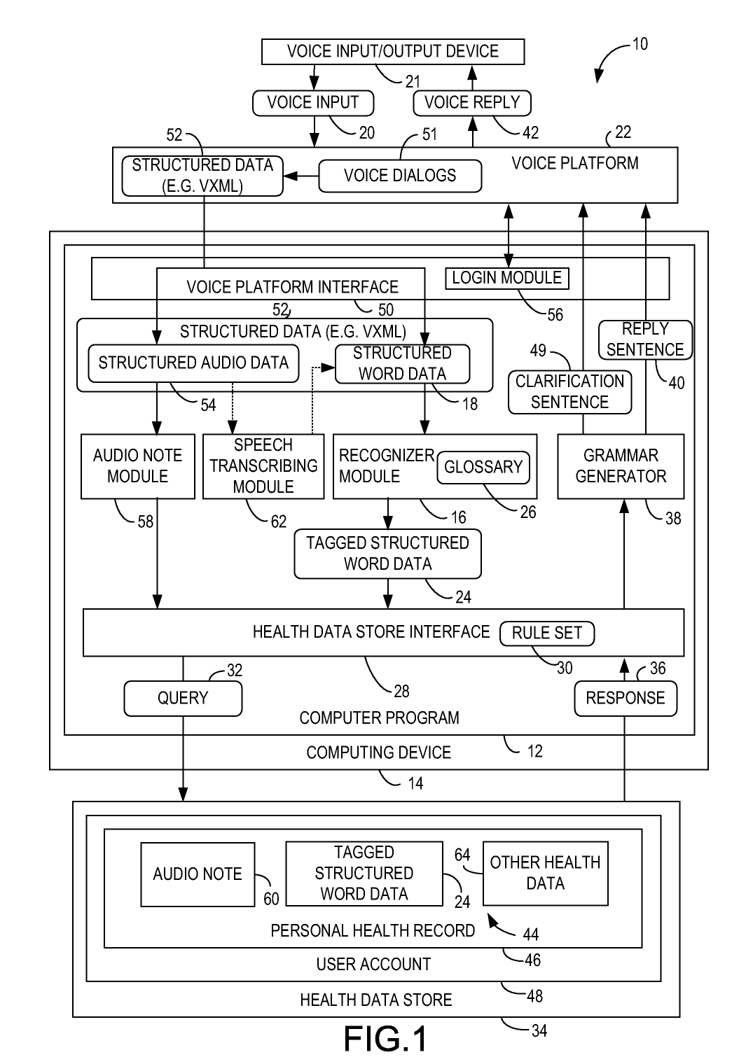

FIG. 1 illustrates an example of a system 10 for enabling user access and update of personal health records stored in a computerized health data store via voice inputs. The system 10 may include a computer program 12 configured to be executed on a computing device 14, to facilitate data exchange between a voice platform 22 and a health data store 34. The voice platform 22 may be configured to receive a voice input 20 from a voice input/output device 21 and send a voice reply 42 to the voice input/output device 21, based on instructions received from the computer program 12. It will be appreciated that the voice input/output device 21 may, for example be a telephone configured to operate over the public switched telephone network (PSTN) or over voice over internet protocol (VoIP), or other suitable voice input/output device.

The voice platform 22 may be configured to present voice dialogs 51 that are encoded in documents according to a format such as the voice extensible markup language (VXML). The voice dialogs 51 contain programmatic instructions according to which voice prompts, menus, etc., are presented to the user, and voice input 20 is received and processed. The voice input 20 generated as a result of these voice dialogs may be processed by the voice platform 22 and saved as structured data 52 in a format such as VXML.

It will be appreciated that during the VXML processing, speech recognition may be performed by the voice platform 22 on the voice input 20, to thereby convert portions of the voice input 20 into text data, which is saved as structured word data 18 in the structured data 52. The structured word data 18 may therefore include word data of the voice input 20 and metadata tags associated with the word data. These metadata tags may, for example, be VXML or other tags that indicate a type, amount, or other descriptive information about the word data.

Further, according to programmatic instructions in the voice dialogs, 51 all or part of the voice input 20 may be received without speech recognition, and may be saved as structured audio data 54 within structured data 52. The structured audio data 54 may include audio data of the voice input 20 and metadata tags associated with the audio data, which may be VXML or other tags that indicate a type, amount, or other descriptive information about the structured audio data, such as whether to save the audio data as an audio note and/or to transcribe the audio data during downstream processing.

In the manner described above, the voice platform 22 may receive voice input 20, and convert the voice input 20 into structured data 52, such as VXML, containing structured audio data 54 and/or structured word data 18.

The computer program 12 may include a voice platform interface 50 for interfacing with voice platform 22. The voice platform interface 50 may include a security-enabled login module 56 that is configured to authenticate a user at the beginning of a user session, in order to ensure secured and authorized access to the computer program 12 and health data store 34. The login module 56 may be configured to present a login voice dialog to the user, and to receive a user identifier and password received via voice input 20, or alternatively via keypad or other input received via the voice input/output device 21. The user identifier may be an account number, for example, and the password may, for example, be an alphanumeric string spoken by the user, typed a keypad on the voice input/output device, or may be based on a sound characteristic of the user's speech, etc.

Once the user is securely logged in, the voice platform interface 50 is configured to receive and extract the structured data 52 of user voice input 20 from the voice platform 22, and its constituent structured audio data 54 and structured word data 18. In doing so, the voice platform interface 50 is configured to extract audio data and metadata tags in structured audio data 54, and word data and metadata tags in structured word data 18.

As discussed above, the extracted metadata tags from the structured audio data 54, for example, may contain information that indicates that the structured audio data 54 is an audio note to be saved in the health data store 34, or indicate that structured audio data 54 is private health information that should be passed through speech recognition in the secure environment of the computer program 12, rather than at the voice platform 22. In this manner, a user may save an audio note for a health care provider to review, and/or sensitive medical audio data may be converted to text within the security of the health data store.

The extracted metadata tags from the structured word data 18 may indicate the type of data that the word data pertains to, such as a medicine name, dosage amount, dosage frequency, blood pressure measurement, etc. It will be appreciated that these metadata tags are defined by the voice dialogs used on voice platform 22, as described above, and interpreted by the computer program 12, as described below.

The computer program 12 may further include a recognizer module 16 configured to receive the structured word data 18 of the user voice input 20 from the voice platform interface 50 and process the structured word data 18, to produce a set of tagged structured word data 24 based on a healthcare-specific glossary 26. It will be appreciated that many of the health related words used in the voice dialogs are health care specific and will not be recognizable by the voice platform 22. Thus, a health-specific glossary 26 may be provided in the recognizer module, which contains a glossary of healthcare terms that may be used by a health data store interface 28, described below, to access and update personal health record data element 44 stored in the health data store 34. Further, the health-care specific glossary will contain words that may be recognized by the voice platform, but will further be able to tag those words with metadata that can be used to identify a corresponding data element within health data store 34 to which the word data relates.

While structured word data 18 is passed through reconizer module 16, the computer program 12 may further include an audio note module 58 configured to receive and process the structured audio data 54. In some cases, the audio note module may be configured to save the structured audio data 54 as an audio note 60 in the user account of the health care data store 34. In such a case, the audio note module 58 may be configured to read a metadata tag associated with the structured audio data 54 and determine that the metadata tag indicates that structured audio data 54 is intended as an audio note 60 to be stored in the health data store 34. Once this determination is made the audio note module may process the structured audio data 54, to thereby produce an audio note 60 to be stored in the health data store 34 by the health data store interface 28.

In other cases, the structured audio data 54 may include a metadata tag indicating that the audio data contained therein is to be transcribed (i.e., speech to text recognition is to be performed) by the computer program 12. To enable such transcription, the computer program 12 may further include a speech transcribing module 62 configured to transcribe the structured audio data 54 to structured word data 18, which in turn is to be passed to the recognizer module 16. To transcribe the structured audio data 54 of the voice input 20, the speech transcribing module 62 may identify individual phonemes in the structured audio data 54 and then group the individual phonemes to form syllables, words, phrases, and/or sentences to generate the structured word data 18 of the voice input 20.

Once the output of the speech transcribing module 62 is passed to the reconizer module 16, the reconizer module 16 is configured to produce a set of tagged structured word data 24 based on the healthcare-specific glossary 26, as described above. Transcription within the computer program 12, rather than at the voice platform 22, may be useful, for example, when metadata tags indicate the structured audio data 54 contains private health information that should be converted to text form word data in the secured environment of the computing device 14, rather than at the voice platform 22. This may be initiated at a user's request, or by privacy policies implemented by the voice dialogs 51 on the voice platform 22, for example.

The computer program 12 may additionally include a health data store interface 28 for interfacing with the health data store 34. The health data store interface 28 may be configured to receive the tagged structured word data 24 from the recognizer module 16, and to apply a rule set 30 to the tagged structured word data 24 to produce a query 32 to the health data store 34. The health data store interface 28 may further be configured to receive a response 36 from the health data store 34 based on the query 32. To apply the rule set 30, the health store interface 28 may be configured to identify the metadata tags added by the reconizer module 16, and formulate appropriate queries 32 to the health data store 34, based on the rule set 30 and the recognized metadata tags in the tagged structured word data 24.

The health data store 34 may be a database configured to receive the query 32, perform the requested internal operations, and generate the response 36. The query 32 may include commands for performing a look up, add, modify, and/or delete operation on a personal health record data element 44 stored in the health data store 34, as specified by rule set 30. The response 36 may include a requested personal health record data element 44 of a personal health record 46 retrieved from a user account 48 of the health data store 34, or an acknowledgement that a requested database operation has been successfully performed, for example.

It will be appreciated that in the health data store 34, the personal health records 46 are organized according to individual user accounts 48, which are accessible by the secure login process described above. Through the above described queries 32, personal health record data elements 44 including the audio note 60, tagged structured word data 24 generated by the recognizer, as well as other health data 64, may be stored by the health data store interface 28 in the personal health records 46 of the user account 48.

The health data store interface 28 may be further configured to generate a clarification sentence 49 to the user to elicit additional user voice input 20 from the user, when the health data store interface 28 determines that it has insufficient information to generate a reply sentence 40. This determination may be made based on application of the rule set 30 and/or based on the response 36 received from the health data store 34. Data for generating the clarification sentence 49 may be passed through a grammar generator 38, for conversion to VXML or other suitable format, and for transmission, through voice platform interface 50, to the voice platform 22. One example scenario in which a clarification sentence 49 may be used is when there are multiple possible actions that the computer program 12 could take on the health data store 34 based on the originally received voice input 20, and clarification is desired to determine which action to take. Another possible scenario for a clarification sentence is when a word or phrase in the voice input is not recognized by the recognizer module.

If the health data store interface 28 determines that it has sufficient information to generate a reply sentence 40, based on the response received from the health data store 34 and/or the rule set 30, then the health data store interface 28 may generate a reply sentence 40 to be passed through grammar generator 38 for delivery to voice platform 22. The health data store interface 28 passes data for formulating the reply sentence 40 to the grammar generator 38. The grammar generator 38 is configured to generate the reply sentence in a suitable format such as VXML. The grammar generator 38 may be further configured to pass the reply sentence 40 to the voice platform 22 to be played as an audio voice reply 42 to the user.

It will be appreciated that the process of soliciting voice input 20, accessing user account 48 in the health data store 34, and generating voice replies 42, in the above described manner continues according to the logic contained in the voice dialogs 51 on voice platform 22, until it is determined that the active voice dialog 51 is over, at which point the call between the voice platform 22 and the voice input/output device 21 may be terminated.

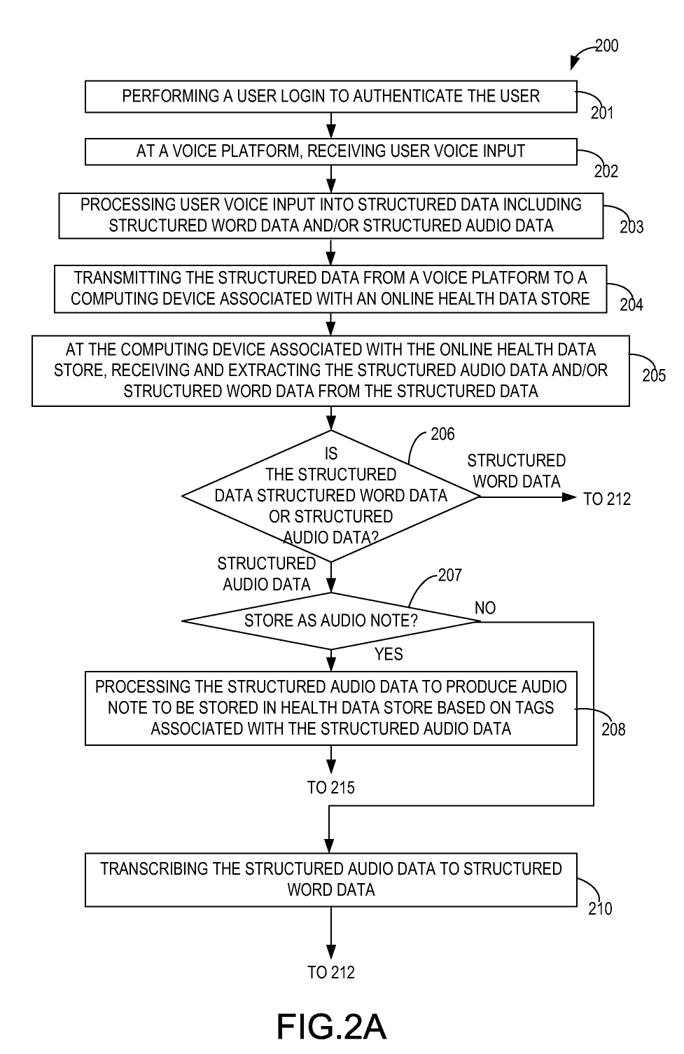

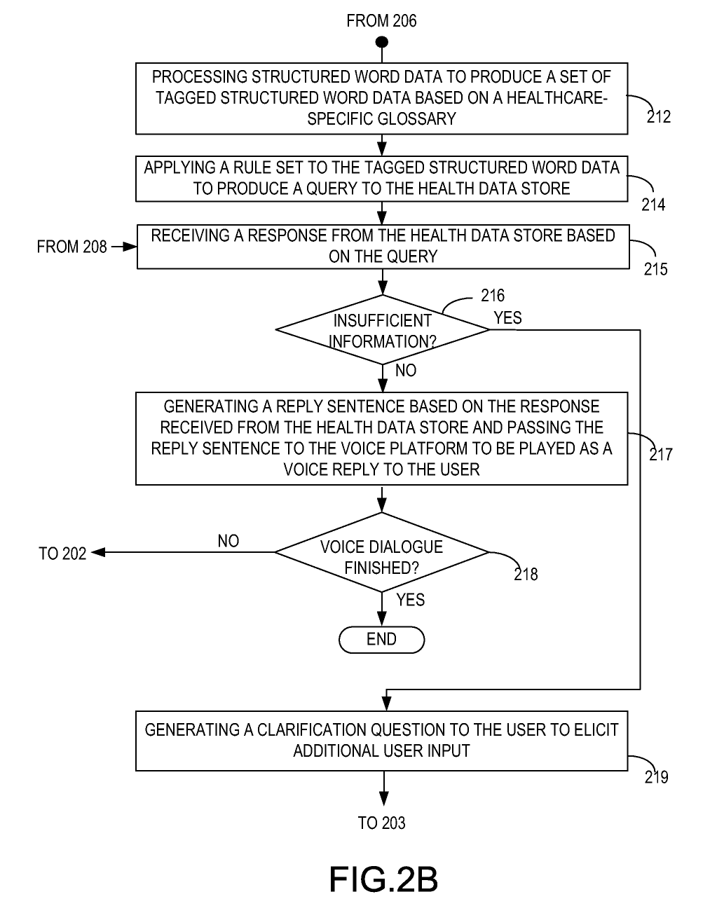

FIGS. 2A & 2B illustrate a flowchart of an example computer-based method 200 for enabling user access and update of personal health records stored in a health data store via voice inputs. The method 200 may be implemented using the computer hardware and software components of system 10 described above, or other suitable computer hardware and software, as appropriate.

The method 200 may include, at 201, performing a secure user login to authenticate a user. The user authentication may be based on login identification and password or may be based on one or more sound characteristics of the user's voice, or other suitable authentication methods, as described above. The login may occur as part of a voice dialog presented by a voice platform, and the user may be in communication with the voice platform using a wired or wireless telephone connected to the PSTN, or via a VoIP enabled telephone, as discussed above.

At 202, the method may include receiving user voice input. The voice input may be received via the voice platform from the voice input/output device. The voice input may be solicited by a voice dialog presented by the voice platform, as described above.

At 203, the method may include processing the voice input into structured data including structured word data and/or structured audio data, as described above. In some embodiments, the structured data may be in a VXML format. At 204, the method includes transmitting the structured data from a voice platform to a computing device associated with an online health data store.

At 205, the method includes receiving from the voice platform structured data representing the voice input, and extracting structured audio data and/or structured word data from the structured data representing the voice input. As described above, the structured audio data may include audio data of the voice input and metadata tags associated with the audio data, and the structured word data may include word data of the voice input and metadata tags associated with the word data. The metadata tags, audio data, and word data may be of the various types described above.

At 206, the method may include determining whether the structured data is structured word data or structured audio data. The determination may be based on the tags associated with the structured data, as described above. If the structured data is structured audio data, the method proceeds to 207, otherwise, if the structured data is structured word data, the method proceeds to 212. If both structured word data and structured audio data are included in the structured data, it will be appreciated that each branch of the flowchart may be traversed, either in parallel or series, as appropriate.

At 207, the method includes determining whether the structured audio data is to be stored as an audio note. This determination may be made by referencing metadata tags associated with the structured audio data. If the structured audio data is to be stored as an audio note, then the method proceeds to 208, otherwise, the method proceeds to 210.

At 208, the method may include processing the structured audio data to produce an audio note to be stored in the health data store based on the metadata tags associated with the structured audio data. As described above, this may involve sending a database query to the health data store instructing the health data store to add the structured audio data as an audio file in a user account. After such a query has been sent, the methods proceeds to 215 to await a response from the health data store indicating that the requested action has been performed successfully.

If at 207 it is determined that the structured audio data is not to be saved as an audio note, the method may determine that the structured audio data is to be transcribed and saved as structured word data. Thus, at 210, the method may include transcribing the structured audio data to structured word data to be recognized to produce a set of tagged structured word data based on a healthcare-specific glossary. The transcribing may include speech to text recognition of audio data containing user voice input, and may result in structured word data representing the voice input, as described above. This speech to text recognition may be performed at a speech transcription module within the secure environment of the computing device associated with the health data store, rather than at the voice platform, to properly protect a user's privacy.

As shown at 212, as a result of the above described process flows, structured word data of a user voice input from the voice platform at 206, and/or structured word data of a user voice input that has been transcribed by a speech transcription module at the health data store at 210, may be processed to produce a set of tagged structured word data based on a healthcare-specific glossary. As described above, the health-specific glossary may include a glossary of healthcare related terms that will facilitate the user access and update of personal health record data element stored in the health data store.

At 214, the method may include applying a rule set to the tagged structured word data to produce a query to the healthcare information database. The rule set may be configured to suit various voice dialogs presented by the voice platform. The query may include commands for performing a look up, add, modify, or delete operation on a personal health record data element stored in the health data store.

At 215, the method may include receiving a response from the health data store based on the query. The response may include an acknowledgement that the action requested by the query has been successfully performed, and also may include a personal health record data element retrieved from the health data store.

At 216, the method may include determining whether insufficient information exists to generate a reply sentence for presentation to the user, according to the voice dialog. This determination may be made based on the response received from the health data store and/or based on the rule set. If it is determined that there is insufficient information to generate a reply sentence, then the method proceeds to 219, where the method includes generating a clarification sentence to elicit additional voice input from the user. As discussed above, the data for generating the clarification sentence may be passed to a grammar generator, which is configured to generate a clarification sentence in a format such as VXML. The clarification sentence may be passed from the grammar generator to the voice platform, via the voice platform interface. The clarification sentence may be presented as a voice reply to the user via the voice platform. The method then returns to 202, for receiving additional voice input from the user.

On the other hand, if at 216 the method determines that sufficient information is possessed to generate a reply sentence, then the method proceeds to 217, where the method further includes generating a reply sentence based on the response received from the health data store and passing the reply sentence to the voice platform to be played as a voice reply to the user.

At 218, the method may include determining whether voice dialogue with the user is finished. If it is determined that the voice dialogue is finished, the method ends. If not, the method may returns to 202 to receive additional voice input from the user and complete the voice dialog.

### EXAMPLE USE SCENARIOS

Example use scenarios of the above described embodiments will now be described. A user may dial in to the voice platform via a voice input/output device, such as a telephone. After securely logging in, a voice dialog may be presented to the user, which presents various menu options for accessing and storing personal health data in a user account on the health data store.

The user may navigate to a “Retrieve health record” section of a voice menu hierarchy of a voice dialog, and may speak into the voice input/output device, “What was my blood pressure yesterday?” This speech is processed by the by the voice platform into the words “What” “was” “my” “blood” pressure” “yesterday”, and is saved with the metadata tag “Retrieve health record”. This data is passed from the voice platform, to the computer program associated with the health data store, through the voice platform interface, which extracts the structured word data contained therein and passes the output to a recognizer module. The recognizer module may parse the words, and identify that “blood” and “pressure” correspond to a “blood pressure” entry in the health care glossary. The recognizer may then tag the structured word data to include a metadata tag indicative of blood pressure measurements stored in the health data store, and pass the tagged structured word data on to a health data store interface.

The health data store interface, in turn, may identify “yesterday” by date, and form a query to retrieve a blood pressure measurement with a date corresponding to yesterday from the user's account on the health care data store. Stored values, such as “95” and “65”, may be returned as a response from the health data store. The health data store interface may interpret the data according to a suitable schema, as systolic pressure being 95 mmHg and diastolic pressure being 65 mmHg. The health data store interface may be configured to generate a reply sentence, by sending word data such as “Your” “blood pressure” “yesterday” “was” “95” “over” “65”, which may be passed to a grammar generator for formulation in a format such as VXML. The reply sentence may be passed to the voice platform and spoken to the user as a voice reply.

As another example, the user may navigate to a “Store health record” menu option in the voice dialog, in order to store a blood pressure reading. The user may speak the words “Today my blood pressure was 95 over 70.” As described above, these words may be sent as structured word data to the recognizer module, which may be configured to tag the structured word data with a metadata tag indicating that the sentence relates to storing a blood pressure measurement in the health data store. The tagged structured word data may be passed to a health data store interface, which may apply the rule set to determine that the first number “95” in the structure word data is systolic pressure in mmHg, and the second number “70” is diastolic pressure in mmHg. The health care interface may be configured to send a query to the health care data store to store the 95 and 70 values along with today's date in the users account, according to a preestablished database schema. An acknowledgement that the storage operation was successfully carried out may be sent to the health care interface from the health care data store, and a reply sentence such as “Your blood pressure from today has been saved” may be generated and spoken as a voice reply to the user.

Alternatively, in the above scenario if the user had spoken “Today my blood pressure was 70 over 95.” The health data store interface may be configured to apply the rule set and determine that the diastolic pressure cannot be higher than the systolic pressure, and may be configured to generate a clarification sentence, such as “Did you mean your blood pressure was 95 over 70?” The user may respond by speaking “Yes”, and in response the system will store the clarified input into the user's account on the health data store.

Further, the user may decide to save an audio note on the system, for example, to be listened to by a doctor at a later date. The user may access a “Save audio note without transcription” menu option in the voice dialog, and speak the words “I am not feeling well today. My head hurts and I am feeling dizzy.” The voice dialog on the voice platform saves these words as structured audio data with a metadata tag indicating the audio data is to be stored on the health data store as an audio note, without transcription. The structured audio data is passed from the voice platform to an audio note module via the voice platform interface. The audio note module determines from the metadata that the structured audio data is to be saved as an audio file without transcription. The audio note module is configured to pass the audio note to the health data store interface, which in turn is configured to send a query to store the audio note as an audio file in the user's account on the health data store. Upon receiving a response from the health data store that the audio note has been stored in the user account, the health data store interface is configured to send an a reply sentence to the user, which may be communicated to the user via a voice reply such as “Your audio note has been saved.”

The above described systems and methods may enable a user to easily and securely access personal health data in a user account stored on a computerized health data store, via voice inputs spoken through a telephone, for example.

It will be appreciated that the computing devices described herein typically include a processor and associated volatile and non-volatile memory, and are configured to execute programs stored in non-volatile memory using portions of volatile memory and the processor. As used herein, the term “program” refers to software or firmware components that may be executed by, or utilized by, one or more computing devices described herein, and is meant to encompass individual or groups of executable files, data files, libraries, drivers, scripts, database records, etc. It will be appreciated that computer-readable media may be provided having program instructions stored thereon, which upon execution by a computing device, cause the computing device to execute the methods described above and cause operation of the systems described above. The methods described herein may be performed in the order described, but are not so limited, as it will be appreciated by those skilled in the art that one or more steps of the method may be performed prior to, or after other steps, in alternative embodiments.

It will also be appreciated that the various components of the system provided herein may communicate directly or via a communication network, which may be or include a wide area network (WAN), a local area network (LAN), a global network such as the Internet, a telephone network such as a public switch telephone network, a wireless communication network, a cellular network, an intranet, or the like, or any combination thereof. For example, communications between voice input/output device 21 and voice platform 22 may occur over a PSTN or the Internet, communications between voice platform 22 and the computing device 14 associated with the health data store 34 may take place over the Internet, and communications between computing device 14 and health data store 34 may take place over a LAN. Of course, it will be appreciated that other network topologies may also be employed.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A system for enabling user access and update of personal health records stored in a computerized health data store via voice inputs, comprising a computer program configured to be executed on a computing device, the computer program including:
a recognizer module configured to process structured word data of a user voice input received from a voice platform, to produce a set of tagged structured word data based on a healthcare-specific glossary;
a health data store interface configured to apply a rule set to the tagged structured word data to produce a query to the health data store and receive a response from the health data store based on the query; and
a grammar generator configured to generate a reply sentence based on the response received from the health data store and pass the reply sentence to the voice platform to be played as a voice reply to the user.

2. The system of claim 1, wherein the computer program further includes a security-enabled login module configured to authenticate the user.

3. The system of claim 1, wherein the computer program further includes a voice platform interface configured to extract structured data from the voice platform.

4. The system of claim 1, wherein the structure data includes structured audio data and the structured word data, the structured audio data including audio data of the voice input and metadata tags associated with the audio data, the structured word data including word data of the voice input and metadata tags associated with the word data.

5. The system of claim 4, wherein the structured data is encoded in a VXML format and the voice platform interface is configured to extract the structured data that is encoded in the VXML format.

6. The system of claim 4, wherein the computer program further includes an audio note module configured to process the structured audio data to produce an audio note to be stored in health data store by the health data store interface based on the tags associated with the structured audio data.

7. The system of claim 4, wherein the computer program further includes a speech transcribing module configured to transcribe the structured audio data to structured word data to be passed to the recognizer module to produce a set of tagged structured word data based on the healthcare-specific glossary.

8. The system of claim 1, wherein the query includes commands for performing a look up, add, modify, and/or delete operation on a personal health record data element stored in the health data store.

9. The system of claim 1, wherein the response includes a personal health record data element retrieved from the health data store.

10. The system of claim 1, wherein the health data store interface is further configured to generate a clarification sentence to elicit additional user input, when the health data store interface determines that it has insufficient information for generating a reply sentence.

11. A computer-based method of enabling user access and update of personal health records stored in a computerized health data store via voice inputs, comprising:
processing structured word data of a user voice input received from a voice platform, to produce a set of tagged structured word data based on a healthcare-specific glossary;
applying a rule set to the tagged structured word data to produce a query to the health data store and receive a response from the health data store based on the query; and
generating a reply sentence based on the response received from the health data store and passing the reply sentence to the voice platform to be played as a voice reply to the user.

12. The method of claim 11, further comprising performing a user login to authenticate the user.

13. The method of claim 11, further comprising, prior to processing,
receiving from the voice platform structured data representing the voice input; and
extracting structured audio data and/or structured word data from the structured data, the structured audio data including audio data of the voice input and metadata tags associated with the audio data, and the structured word data including word data of the voice input and metadata tags associated with the word data.

14. The method of claim 13, wherein the voice platform interface is configured to extract structured data that is encoded in a VXML format.

15. The method of claim 13, further comprising processing the structured audio data to produce an audio note to be stored in health data store based on the metadata tags associated with the structured audio data.

16. The method of claim 13, further comprising transcribing the structured audio data to structured word data to be recognized to produce a set of tagged structured word data based on a healthcare-specific glossary.

17. The method of claim 11, wherein the query includes commands for performing a look up, add, modify, and/or delete operation on a personal health record data element stored in the health data store.

18. The method of claim 11, wherein the response includes a personal health record data element retrieved from the health data store.

19. The method of claim 11, further comprising:
prior to generating the reply sentence, determining that insufficient information exists to generate the reply sentence for presentation to the user based on the response received from the health data store and/or based on the rule set; and
generating a clarification sentence to elicit additional voice input from the user.

20. A system for enabling user access and update of personal health records stored in a computerized health data store via voice inputs, comprising a computer program configured to be executed on a computing device, the computer program including:
a security-enabled login module configured to perform a user login to authenticate the user;
a voice platform interface configured to extract structured data from the voice platform, wherein the structure data includes structured audio data and structured word data, the structured audio data including audio data of the voice input and metadata tags associated with the audio data, the structured word data including word data of the voice input and metadata tags associated with the word data;
a recognizer module configured to process structured word data of a user voice input received from a voice platform, to produce a set of tagged structured word data based on a healthcare-specific glossary;
a health data store interface configured to apply a rule set to the tagged structured word data to produce a query to the health data store and receive a response from the health data store based on the query;
a grammar generator configured to generate a reply sentence based on the response received from the health data store and pass the reply sentence to the voice platform to be played as a voice reply to the user; and
an audio note module configured to process the structured audio data to produce an audio note to be stored in health data store by the health data store interface based on the tags associated with the structured audio data.
